(19) United States
(12) Patent Application Publication
(10) Pub. No.: US 2010/0330342 A1
(43) Pub. Date: Dec. 30, 2010

(54) Coating arrangement

(75) Inventors: Peter Horling, Schonungen (DE); Wolfgang Gläntz, Schweinfurt (DE)

Correspondence Address: Mark A. Ussai;SKF USA Inc., 890 Forty Foot Road, PO Box 332, Kulpsville, PA, 19443, US

(73) Assignee: Aktiebolaget SKF, Goteborg (SE)

(21) Appl. No.: 12/658,348

(22) Filed: Feb. 5, 2010

(30) Foreign Application Priority Data
Feb. 2, 2009 (DE) 10 2009 007 992.0

(51) Int. Cl. B32B 3/00; B32B 5/16; B32B 15/04; B32B 7/02

(52) U.S. Cl. 428/172; 428/323; 428/457; 428/217

(57) ABSTRACT

A coating arrangement includes a coating carrier having at least one surface and a coating having particles with a hardness of at least 9 on the Mohs hardness scale disposed on the at least one surface of the coating carrier. The particles forming substantially a single layer and being fixed on the carrier surface by a metallic material applied by electroplating. Such a coating arrangement may be used in a coupling that further includes a counter element against which the coating arrangement is intended to press.

The present application claims priority to German Patent Application No. 10 2009 007 992.0 filed on Feb. 2, 2009, the contents of which are fully incorporated herein by reference.

The invention relates to a coating arrangement, more particularly to a coating arrangement for couplings such as shaft couplings.

Friction-increasing coatings are known, but for many applications, the static friction coefficients achievable with these coatings are not increased to a desirable extent.

### SUMMARY OF THE INVENTION

An object of the invention, therefore, is to provide an improved coating arrangement, by means of which, in particular, high static friction coefficients can be achieved.

In one aspect, the present invention is a coating arrangement comprising a coating carrier having at least one surface and a coating having particles with a hardness of at least 9 on the Mohs hardness scale disposed on the at least one surface of the coating carrier. The particles forming substantially a single layer and being fixed on the carrier surface by a metallic material applied by electroplating.

In another aspect, the present invention is a coupling comprising a coating arrangement including a coating carrier having at least one surface and a coating having particles with a hardness of at least 9 on the Mohs hardness scale disposed on the at least one surface of the coating carrier. The particles form substantially a single layer and are fixed on the carrier surface by a metallic material applied by electroplating. A counter element against which the coating arrangement is intended to press is provided.

Only by combining a highly accurate application of the particles in one or a few layers with a subsequent fixing of the particles by means of a metal, in particular nickel, applied by electroplating, so that virtually one particle layer is fixed, while, in the application of a plurality of layers, the excess layers are removed, for example, by brushing after fixing, can a coating be achieved in which, for example, particle regions projecting out of the nickel layer amount to more than 25% and even up to 40% of the surface of the coating, whereby, ultimately, very high static friction coefficients greater than 0.7 and even above 0.8 can be achieved. In this case, the term “virtually single-layer” is to be understood as meaning that, in a predominant fraction of the coated surface, in particular greater than 75%, actually only one layer of particles is fixed, and the particles can also adhere, multi-layer, in particular 2-layer, only in smaller part-regions of the coated surface.

In an advantageous refinement, the coating comprises nickel applied by electroplating, so that, at the same time, an excellent protective layer against corrosion-causing and other environmental influences is generated for the coating carrier.

In an advantageous refinement, the coating carrier is designed with a greater Mohs' hardness and/or a greater tensile strength than a counter element, against which the coating arrangement is intended to press, so that, as desired, those regions of the particles which project above the coating press into the counter element, and the coating beneath the particles and also the region of the coating carrier beneath the particles are deformed only insignificantly, as compared with pressing into the counter element.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 shows, in the form of a detail, a longitudinal section through a rigid shaft coupling of two shaft elements with a structural element resembling a perforated disc between the two flange-like shaft ends, and

FIG. 2 shows a front view of the structural element resembling a perforated disc from FIG. 1, on which a coating is applied.

### DETAILED DESCRIPTION OF THE INVENTION

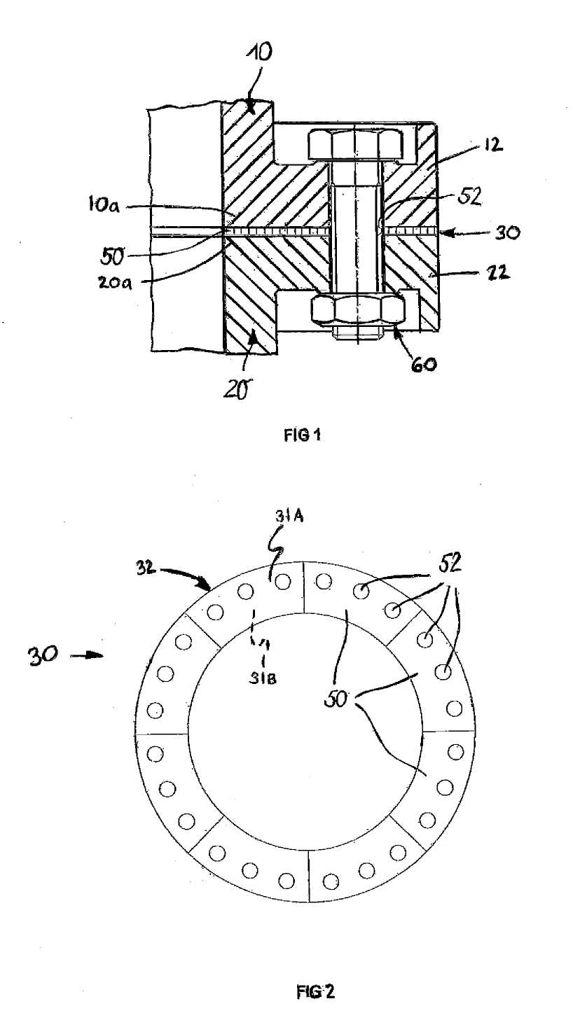

FIG. 1 shows, as an exemplary embodiment of the invention, a longitudinal section through a rigid coupling 1 comprising two members, preferably two shaft elements 10, 20 which are connectable to form a hollow shaft, such as for example, a main shaft of a wind power plant. Each of the two shaft elements 10, 20 have a shaft end 10a, 20a, respectively, that is widened in a flange-like manner, i.e., each shaft element has a flange 12, 22, respectively, the two flanges 12, 22 being connectable together. Preferably, a coating carrier 30 is disposed between the two flanges 12, 22 and is provided with a coating on at least one end face or surface 31A, 31B. Further, the carrier 30 is preferably formed as a structural element resembling a perforated disc, e.g., as a generally annular disc 32, which may include, or be divided into, a plurality of sector-like subelements 50. Each element 50 preferably has a plurality of through-holes 52, most preferably three holes 52, as shown in FIG. 2. Preferably, each of the flanges 12, 22 of the two shaft elements 10, 20 includes corresponding openings (e.g., through-holes or blind holes) alignable with the carrier holes 52, and a plurality of fasteners 60 (only one shown) preferably extend between the two shaft elements 10, 20 and through the carrier openings 52 so as to connect the shaft elements 10, 12. The carrier 30 may include a “coding means”, for example teeth formed on the outer circumference of the disc 32, which may be used to detect shaft rotational speed.

At least one and preferably both axial end surfaces 31A, 31B of the carrier 30 are provided with the coating to ensure a firm connection between the shaft ends, and thus the two shaft elements 10, 12. The carrier disc 32 is preferably formed of a steel having a tensile strength with a range of about 600 MPa and 800 MPa. The end-face surfaces 31A, 31B of the coating carrier 30 are preferably ground to a surface roughness of Ra≦0.2 μm. Further, the grinding process preferably creates furrow-like depressions with a depth of less than or equal to 4 μm and with a width of less than or equal to 6 μm, and most preferably, the depressions have a depth of less than approximately ten percent (10%) of the coating thickness and/or with a width of less than approximately fifteen percent (15%) of the coating thickness. By providing depressions of such dimensions, the furrow-like depressions ensure optimal adhesion of the coating while reducing the chance that any coating particles disposed within the depressions do not extend above the fixing layer outer surface.

The coating preferably includes an undercoating formed of nickel with a thickness of, for example, approximately 5 μm, which is applied by electroplating to at least one and preferably both ground faces 31A, 31B of the coating carrier 30. A plurality of particles with a hardness of at least 9 on the Mohs scale, and most preferably a Mohs hardness of 10, and a grain size of between 40 μm and 90 μm, are disposed on the undercoating layer in a substantially single layer, but may form a plurality of layers. Preferably, each particle is provided by a sharp-edged or block-like grain of a monocrystalline diamond, for example of a natural diamond. Then, an overcoating of nickel is applied, preferably by electroplating, so that at least a lower region of the particles (i.e., the ends of the particles proximal to the contact surface) on the undercoating are surrounded by the overcoating. Thereby, the particles are fixed or secured in a substantially single layer, and if a plurality of layers have been applied to the undercoating, the outer, excess layers are removed, for example, by brushing after fixing/securing the particle layer with the overcoating.

As mentioned above, both of the end faces or surfaces 31A, 31B of the coating carrier 30 are preferably provided with the coating as described in detail above. The flanges 12, 22 of the two shaft elements 10, 20 are preferably formed of a first material and the carrier faces 31A, 31B are formed of a second material, the second material having a substantially greater hardness than the first material, both in terms of Mohs hardness and tensile strength. Preferably, the shaft flanges 12, 22 are each formed of a grey cast iron, for example GG 40.3 with a tensile strength in the range of between 400 and 500 MPa. Each flange 12, 22 has a connection surface or face 13, 23, respectively, disposeable against or contactable with the carrier 30, each face 13, 23 preferably having a roughness Ra in the range of between 0.5 μM and 1.5 μm.

When the carrier 30 is disposed between the two shaft ends 10a, 20a and the flanges 12, 22 are fastened together, the diamond particles press into the grey cast iron during fastening such that the carrier 30 is connected inter-engagingly with the shaft ends 10a, 20a. Specifically, the two shaft ends 10a, 20a are preferably pressed against one another with a pressure per unit area of about 90 MPa to about 180 MPa. In other words, each shaft element 10, 20 contacts the coating carrier 30 with a pressure having a value within a range of about 90 MPa and 180 MPa. During fastening, the undercoating layer beneath the diamond particles is only slightly compressed in the direction of the carrier 30.

With this structure, the static friction coefficients between the shaft ends 10a, 20a and the carrier 30 greater than 0.7, and preferably greater than 0.8, are present within the coupling. Furthermore, the nickel undercoating provides excellent corrosion protection for the steel coating carrier 30, so that the carrier disc 32 is protected reliably against the most adverse climatic conditions. As a further result, with a connection having the above-described coating, the number of required fasteners can be reduced in comparison with conventional connections, while the strength of the connection remains the same.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

We claim:

1. A coating arrangement comprising:
a coating carrier having at least one surface; and
a coating having particles with a hardness of at least 9 on the Mohs hardness scale disposed on the at least one surface of the coating carrier, the particles forming substantially a single layer and being fixed on the carrier surface by a metallic material applied by electroplating.

2. The coating arrangement as recited in claim 1 wherein the coating includes an undercoating layer formed of a metallic material disposed between the layer of particles and the carrier surface.

3. The coating arrangement as recited in claim 2 wherein the metallic material fixing the particles and the metallic material forming the undercoating layer are substantially identical.

4. The coating arrangement as recited in claim 1 wherein each of the coating particles has a particle size within a range of about 40 μm and 90 μm.

5. The coating arrangement as recited in claim 1 wherein the at least one carrier surface is ground prior to applying the coating so as to form a plurality of depressions.

6. The coating arrangement as recited in claim 5 wherein at least eighty-five percent of the depressions have at least one of a depth of less then approximately ten percent of the coating thickness and a width of less then fifteen percent of the coating thickness.

7. The coating arrangement as recited in claim 5 wherein each of the depression is formed having a depth of less than or equal to 6 μm and a width of less than about 8 μm.

8. The coating arrangement as recited in claim 1 wherein the at least one carrier surface having the coating is ground to a roughness of Ra≦0.2 μm prior to applying the coating.

9. The coating arrangement as recited in claim 1 wherein the coating carrier is formed from a steel having a tensile strength within a range of about 600 MPa and about 800 MPa.

10. The coating arrangement as recited in claim 1 wherein each of the coating particles is formed of monocrystalline diamond.

11. The coating arrangement as recited in claim 1 wherein the coating carrier includes an annular disc.

12. The coating arrangement as recited in claim 11 wherein the coating carrier disc includes a plurality of sector-like subelements.

13. The coating arrangement as recited in claim 1 wherein the coating carrier has a plurality of through-holes, each through-hole being configured to receive a fastener.

14. The coating arrangement as recited in claim 1 wherein each of the coating arrangement is configured for use in a rigid shaft coupling.

15. The coating arrangement as recited in claim 1 wherein the coating carrier has a coding means for detecting shaft rotational speed.

16. A coupling comprising:
a coating arrangement including a coating carrier having at least one surface and a coating having particles with a hardness of at least 9 on the Mohs hardness scale disposed on the at least one surface of the coating carrier, the particles forming substantially a single layer and being fixed on the carrier surface by a metallic material applied by electroplating; and
a counter element against which the coating arrangement is intended to press.

17. The coupling as recited in claim 16 wherein the counter element is formed of grey cast iron with a tensile strength within a range of about 400 MPa and about 500 MPa.

18. The coupling as recited in claim 16 wherein the counter element is formed of a material having one of a hardness lesser than the coating carrier and a tensile strength lesser than the coating carrier.
